(19) United States
(12) Patent Application Publication
(10) Pub. No.: US 2005/0180033 A1
(43) Pub. Date: Aug. 18, 2005

(54) Monolithic microelectromechanical system mirror

(76) Inventors: Peter Kurczynski, South Orange, NJ (US); Joseph Ashley Taylor, Springfield, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/779,443

(22) Filed: Feb. 13, 2004

(51) Int. Cl. G02B 26/00; G02B 5/08; G02B 7/182

(52) U.S. Cl. 359/846; 359/296

(57) ABSTRACT

A monolithic mirror assembly is disclosed that is manufactured from a silicon on insulator (SOI) substrate comprising two silicon layers separated by an insulator material. One layer or silicon and the insulator layer are partially etched, thus exposing the underlying second layer of silicon which functions as the reflective surface of the mirror. A first layer of electrodes is disposed on the exposed portion of the insulator area above the reflective surface of the mirror. The mirror is directly mounted on a second substrate comprising a second layer of electrodes. The first and second layers of electrodes are used to variably deform the shape of the mirror to compensate for wave front errors in an optical signal.

### FIELD OF THE INVENTION

The present invention is related generally to the correction of distortion of optical signals and, in particular, to the use of adaptive optics to correct that distortion.

### BACKGROUND OF THE INVENTION

Optical signals are used in many different fields for many different purposes. One particular use of these signals is in optical telecommunication systems designed to transmit voice and data messages. Such telecommunication systems rely on optical components, such as all-optical routers, to process and route data from one point to another. These optical components often use small mirrors or lenses to redirect free-space light beams propagating in one direction to another desired direction. However, the operation of systems using such mirrors to redirect light beams may be hampered by a variety of factors. For example, temperature variations, turbulence or other phenomena may result in a change in the refractive properties of the medium (e.g., the atmosphere) through which the beam passes. Such changes in the refractive properties of the atmosphere between the transmission point and the receiving point may cause certain portions of the beam to move faster than others resulting in the aforementioned distortion. This distortion may cause discrete sections of the wave front to deviate from the orthogonal orientation to the line of travel of the beam as initially transmitted. This deviation may result in significant degradation of the wave front at its destination and, hence, may result in equally significant degradation of the optical signal carried by the light beam.

Adaptive optics, which are well known in the art, typically use a wave front sensor to measure phase aberrations in an optical system and a deformable mirror or other wave front compensating device to correct these aberrations (i.e., to bring the reflected wave front into phase). Until recently, such deformable mirrors were typically deformed via piezoelectric drivers, or other well-known methods. More recent efforts rely incorporate upon electrostatic actuation where a mirror is deformed by passing a voltage across one or more of a plurality of electrodes located in electrostatic proximity to that mirror. By controlling the attractive force along different portions of the mirror surface, the shape of the mirror may be altered in a known way, thereby at least partially correcting for the wave front distortion.

### SUMMARY OF THE INVENTION

The present inventors have recognized that, while prior attempts at using deformable mirrors are advantageous in many regards, they are also disadvantageous in some respects. For example, prior mirrors have insufficient range of deformation to meet the needs of adaptive wave front correction in various applications such as astronomy and vision science. In particular, the method of actuation of such prior mirrors, namely electrostatic attraction to a single underlying electrode plane, allowed only attraction to the electrode plane, and not a corresponding upward motion away from that electrode plane. This feature limited the range of deformation that could be achieved with prior devices. Although some prior mirrors have incorporated a second electrode plane above the mirror in order to allow actuation in both directions, this second electrode was fabricated as a separate entity that could not be located in sufficiently close proximity to the mirror. As a result comparatively little benefit was achieved.

Therefore, the present inventors have invented an integrated, monolithic deformable mirror structure that solves this problem. In accordance with one embodiment of the present invention, a mirror assembly is manufactured from a silicon on insulator (SOI) substrate comprising two silicon layers separated by an insulator material. One layer or silicon and the insulator layer are partially etched, thus exposing the underlying second layer of silicon which functions as the reflective surface of the mirror. A first, transparent layer of electrodes is attached to the exposed portion of the insulator area above the reflective surface of the mirror. An integrated, monolithic mirror structure is formed by bonding the mirror to a second chip (also referred to herein as a support structure) which includes a second layer of electrodes. The first and second layers of electrodes are used to variably deform the shape of the mirror to compensate for wave front errors in an optical signal.

### BRIEF DESCRIPTION OF THE DRAWING

FIG. 1A shows a bulk silicon on insulator such as is useful in accordance with the principles of the present invention;

FIGS. 1B and 1C show one embodiment of etching the substrate of FIG. 1A to form a small mirror in accordance with the principles of the present invention;

FIG. 2 shows a side view and a top view of the mirror of FIG. 1C;

FIG. 3A shows an illustrative substrate useful in accordance with the principles of the present invention for supporting the mirror of FIG. 2;

FIG. 3B shows one embodiment illustrating how the substrate of FIG. 3B may be etched and patterned with a first layer of electrodes in accordance with the principles of the present invention;

FIGS. 4A and 4B show the mirror of FIG. 2 disposed on the support of FIG. 3B thus forming an integrated mirror structure in accordance with one embodiment of the present invention; and

FIG. 5 shows an integrated monolithic mirror whereby, by applying voltages to electrodes in proximity to the reflective surface of the mirror, the mirror may be adaptively deformed to correct for wavefront distortion of a light beam.

### DETAILED DESCRIPTION OF THE INVENTION

As previously discussed, wave front distortion may result when any changes to the refractive properties of the transmitting medium are encountered along the line of travel of a light beam. These changes may cause discrete sections of the wave front of the beam to deviate from their transmitted, orthogonal orientation to the line of travel of the beam. The result is a distortion of the image of the wave front when it reaches its destination, which may be for example a mirror, a focal plane of a telescope, an optical wave front sensor (e.g., a curvature wave front sensor or a Shack-Hartman wave front sensor), or any other destination. By way of example, in optical communications systems, distortion may result in significant degradation of the communications signal or even the total loss of communications.

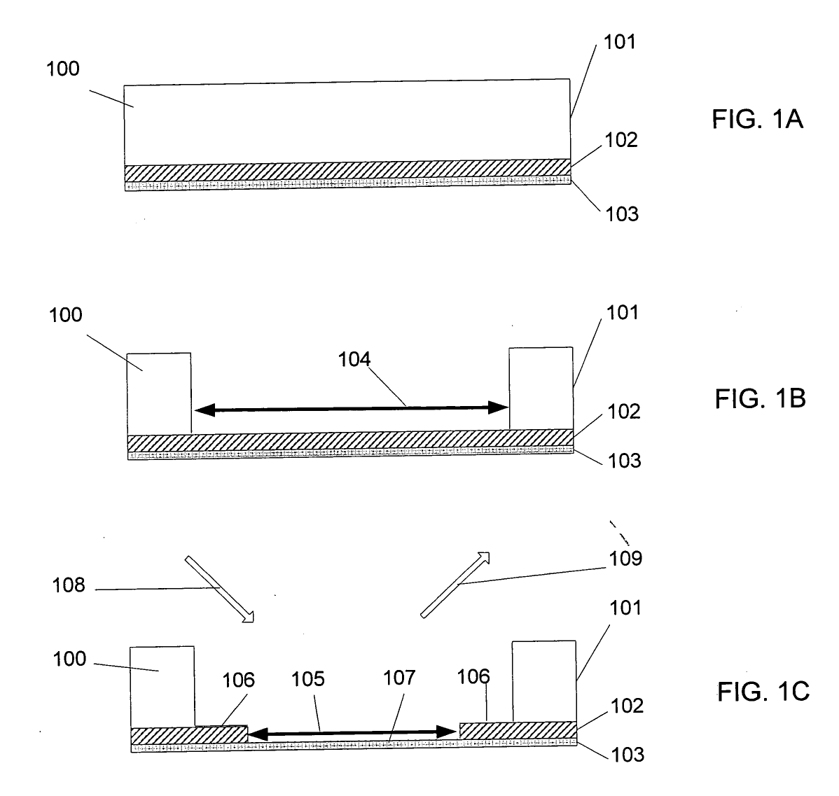

FIG. 1A shows substrate 100 useful for forming a small reflective mirror such as that used to correct for wave front distortion in an optical communications system. Substrate 100 is, for example, a silicon-on-insulator (SOI) substrate having, illustratively, silicon layer 101 disposed on layer 102, which is, illustratively, an insulating oxide layer (e.g., silicon dioxide). Layer 102 is, in turn, disposed on layer 103 which is, illustratively, a thin layer (e.g., a layer of 1 micron or thinner) of material such as silicon nitride, single crystal silicon, polysilicon, polyimide, or other known materials. FIGS. 1B and 1C show how substrate 100 may be etched to form a micro mirror. Specifically, referring to FIG. 1B, an area of layer 101, represented by length 104, is etched using well-known etching techniques to expose a portion of the underlying insulator layer 102. Next, as shown in FIG. 1C, a portion of layer 102, illustratively that portion represented by length 105, is etched away to expose layer 103. Length 105 is, for example, shorter than length 104 so that, once etching is complete, supporting steps 106 of layer 102 remain exposed. Accordingly, the structure of FIG. 1C is a mirror structure having reflective surface 107. Thus, for example, a light beam traveling in direction 108 is, upon reaching surface 107, reflected from surface 107 and redirected in illustrative direction 109. A metallic coating (e.g., aluminum) may be formed on surface 107 to enhance this reflectivity.

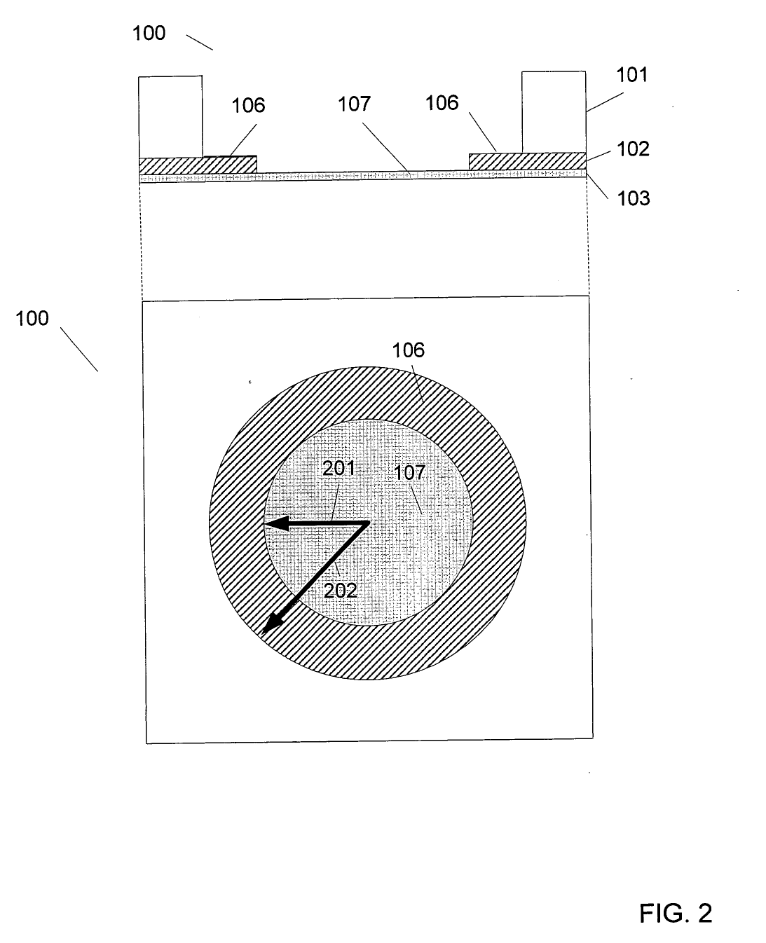

FIG. 2 shows a top view of the mirror structure of FIG. 1C. Illustratively, referring to FIG. 2, the etching described above has exposed circular areas 106 and 107 respectively of layers 102 and 103 of substrate 100. One skilled in the art will recognize that tension of mirror surface 107 is maintained due to the support to the mirror surface provided by the remaining portions of layers 101 and 102. Illustratively, radius 201, which is the outer radius of area 107 and the inner radius of area 106 is 5 mm. Similarly, radius 202, which is the outer radius of area 106, is illustratively 5.5 mm. One skilled in the art will recognize that many different shapes and sizes of areas may be etched using well known techniques to form mirrors useful in accordance with the principles of the present invention.

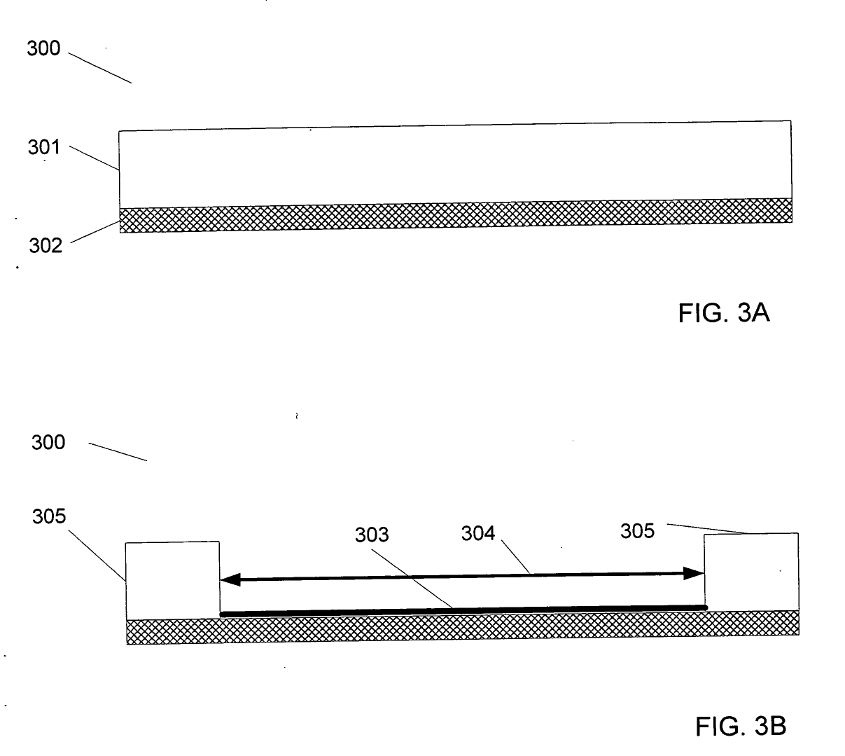

FIG. 3 shows a support substrate 300 which is, illustratively, a substrate having a first layer 301, such as, illustratively, a layer of polyimide material, disposed on a second layer 302, which is, for example, a layer of silicon in a printed circuit board. A support structure is created by, illustratively, etching away a portion of layer 301 to expose a portion of layer 302, resulting in the illustrative etched supporting structure shown in FIG. 3B. In that figure, an area of layer 301 represented by cross section length 304 is etched away exposing, for example, a circular area of layer 302 having a diameter of length 304. A layer 303 of electrodes, such as, illustratively, electrodes useful in adaptive optics applications, is then patterned onto the exposed portion of layer 302 using methods well known to one skilled in the art.

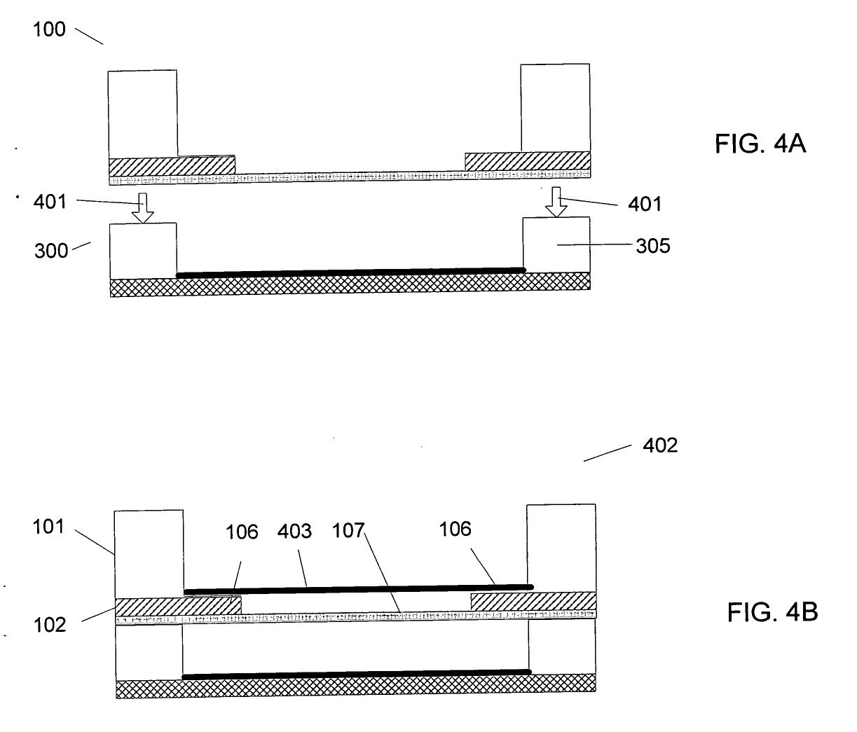

FIG. 4 shows how a monolithic integrated mirror structure useful for correcting wavefront distortion in a light beam may be formed. Specifically, FIG. 4A shows how mirror structure 100 of FIG. 2 is, illustratively, lowered in direction 401 until it is brought into contact with the support structure 300 of FIG. 3B and attached to the illustrative polyimide material 305 of support structure 300. One skilled in the art will recognize that this attachment may be achieved by, for example, flip chip bonding. Thus, the integrated structure 402 is characterized by a reflective layer 107 supported by supporting structure 305 and held in tension by etched layers 101 and 102. Illustratively, a layer 403 of transparent electrodes is disposed such that it is suspended on the remaining exposed portion 106 of insulating layer 102 above the reflective surface 107 of the mirror and in the path of an incoming light beam.

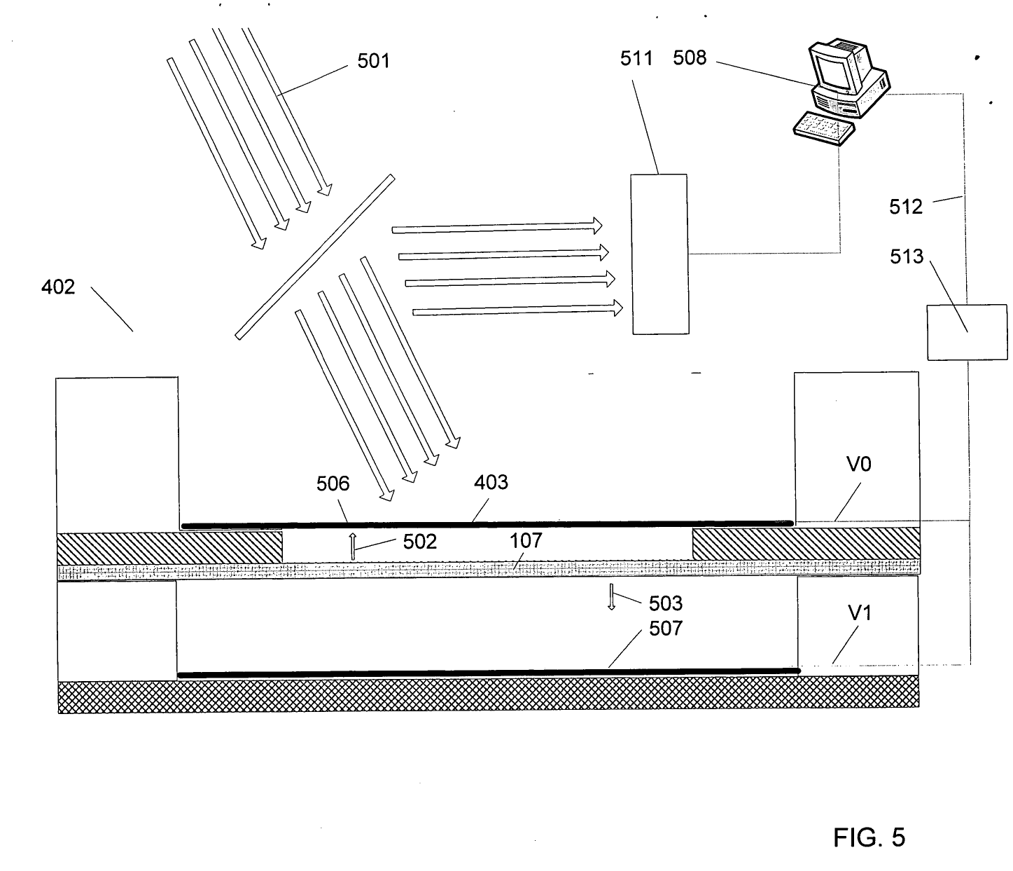

FIG. 5 shows how, in operations, the structure of FIG. 4B may be used to correct for wave front distortion of the light beam 501. Referring to FIG. 5, a light beam 501 propagating toward reflective surface 107 of structure 402 is split by beam splitter 510 such that part of the beam is directed toward illustrative wave front sensor 511. Wave front sensor 511 is, for example, a well-known Shack-Hartmann wave front sensor, which is used to detect the presence and magnitude of wave front distortion in light beam 501. An example of such a wave front sensor, as used in a free space optical communications system, is described in the co-pending U.S. Patent Application titled “Method and Apparatus for the Correction of Optical Signal Wave Front Distortion Within a Free-Space Optical Communications System,” having Ser. No. 09/896804, filed Jun. 29, 2001, which is hereby incorporated in its entirety herein.

As is well known to one skilled in the art of adaptive optics, wave front information collected by the wave front sensor 511 is forwarded to, for example, illustrative computer 508, that, if necessary, determines an appropriate shape of the reflective surface 107 of the mirror that would correct for the wave front distortion once the light beam is incident upon and reflected from reflective surface 107. Computer 508 then generates signals that are forwarded via lead 512 to controller 513 which generates one or more voltages to be passed over one or more electrodes in proximity to mirror reflective surface 107, such as electrodes 506 and 507, in electrode layers 403 and 303. As one skilled in the art will fully appreciate that, when, for example, a voltage V₀ is passed over electrode 506 and a voltage V₁ is passed over electrode 507, electrostatic forces are generated between the electrodes and the mirror. These forces cause, for example, a discrete portion of the mirror to be attracted in direction 502 toward electrode 506 and a discrete portion of the mirror to be attracted in direction 503 toward electrode 507. Generally, within limits, the greater the magnitude of the voltage passed across a particular electrode, the greater the force applied to the mirror and, hence, the greater the displacement of the reflective surface 107 of the mirror relative to its nominal position when no such voltage is applied. Accordingly, by applying a plurality of voltages to a plurality of electrodes in layers 403 and 303, reflective surface 107 of the mirror structure 402 can be deformed in a relatively complex manner in order to compensate for complex, distorted wave fronts. The result is that, upon being reflected, the wave front distortion of the light beam 501 is reduced.

The foregoing merely illustrates the principles of the invention. It will thus be appreciated that those skilled in the art will be able to devise various arrangements that, although not explicitly described or shown herein, embody the principles of the invention and are within its spirit and scope. Furthermore, all examples and conditional language recited herein are intended expressly to be only for pedagogical purposes to aid the reader in understanding the principles of the invention and are to be construed as being without limitation to such specifically recited examples and conditions. Diagrams herein represent conceptual views of mirrors and light beams. Diagrams of optical components are not necessarily shown to scale but are, instead, merely representative of possible physical arrangements of such components.

1. A monolithic adaptive optic mirror comprising:
a deformable mirror structure having a first reflective side and a second side;
a first layer of transmissive electrodes disposed on said mirror structure in electrostatic proximity to said first reflective side;
a support structure adapted to support said deformable mirror structure, said support structure further adapted to support a second layer of transmissive electrodes in electrostatic proximity to said second side of said mirror.

2. The monolithic adaptive optic mirror of claim 1 wherein said first layer of transmissive electrodes is disposed in an optical path of at least a first optical signal.

3. The monolithic adaptive optic mirror of claim 1 wherein said mirror structure is bonded to at least a first surface of said support structure, thus forming a single integrated package.

4. The monolithic adaptive optic mirror of claim 3 wherein said first surface is an insulating surface.

5. The monolithic adaptive optic mirror of claim 1 wherein at least a first voltage passed over at least one of said electrodes in said first layer of electrodes causes said first reflective side of said mirror structure to be attracted toward said at least one of said electrodes in said first layer.

6. The monolithic adaptive optic mirror of claim 1 wherein at least a second voltage passed over at least one of said electrodes in said second layer of electrodes causes said first reflective side of said mirror structure to be attracted toward said at least one of said electrodes in said second layer.
